(19) United States
(12) Patent Application Publication
(10) Pub. No.: US 2014/0188858 A1
(43) Pub. Date: Jul. 3, 2014

(54) SERVER AND METHOD FOR DOWNLOADING FILES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: Chung-I LEE, New Taipei (TW); De-Yi XIE, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/138,131

(22) Filed: Dec. 23, 2013

(30) Foreign Application Priority Data
Dec. 27, 2012 (CN) 2012105805845

(51) Int. Cl. G06F 17/30

(52) U.S. Cl. CPC G06F 17/3053
USPC 707/723

(57) ABSTRACT

A method for downloading files from a server. A first server receives search conditions from a user for downloading files, and determines a file list listing matching files in a second server. The first server sorts the files listed in the file list according to sorting standards input by the user, and obtains a downloading sequence of the files by arranging the sorted files according to a dynamic priority input by the user. Files are then downloaded from the second server according to the downloading sequence.

### BACKGROUND

1. Technical Field

Embodiments of the present disclosure relate to file management technology, and more particularly, to a server and a method for downloading files.

2. Description of related art

Downloading multiple files from a server may put a heavy burden on the server. As a result, a download speed of the files may be very slow, thus users may have to wait a long time for urgently required files.

### BRIEF DESCRIPTION OF THE DRAWINGS

FIG. 1 is a block diagram of one embodiment of a server including a downloading system.

FIG. 2 is a block diagram of one embodiment of function modules of the downloading system in FIG. 1.

FIG. 3 is a flowchart of one embodiment of a method for downloading files.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

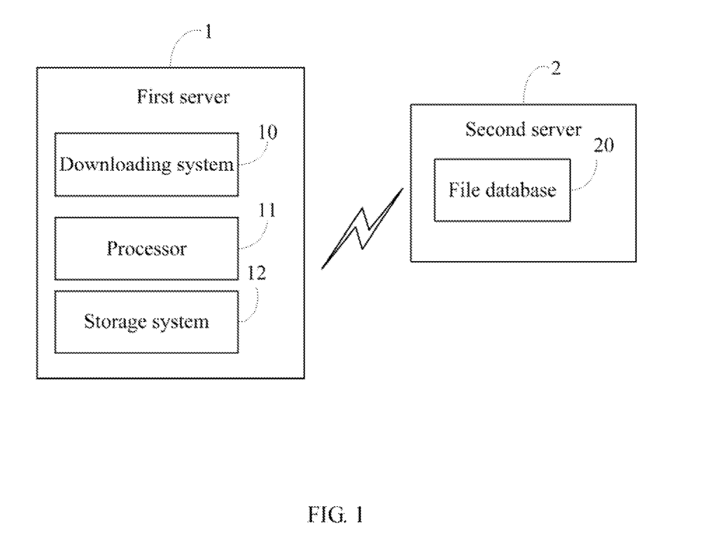

FIG. 1 is a block diagram of one embodiment of a first server 1. The first server 1 includes a downloading system 10, a processor 11, and a storage system 12. The first server 1 connects to a second server 2 via a network. The second server 2 includes a file database 20. The file database 20 stores files and attributes of the files. The attributes include for example a size of each file, an uploading date of each file, and a type code of each file. In one embodiment, the second server 2 may be a national Patent Office server, such as the USPTO server. The files stored in the file database 20 may be an Office Action from the USPTO server. The attributes include a size of each file, an uploading date of each file, and a type code of each file. For example, the attributes of the file may include a number of pages of the Office Action and a date of receiving the Office Action.

The storage system 12 stores a file configuration table. The file configuration table stores the type identifiers of all the files. A type identifier of each file may be a first type identifier or a second type identifier. The files having the first type identifiers are files which need be downloaded. The files having the second type identifiers are files which do not require to be downloaded. The storage system 12 also stores a priority of each file. In one embodiment, the priority of each file may be arranged according to deadline dates of the files.

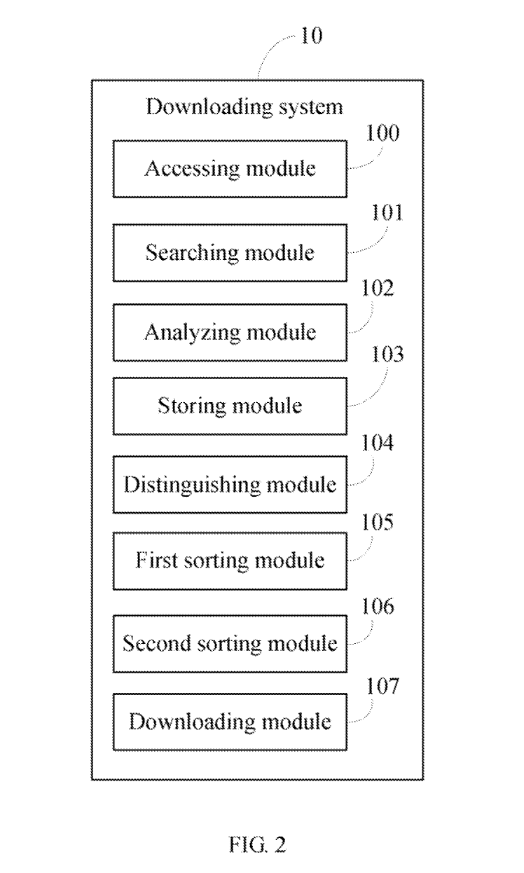

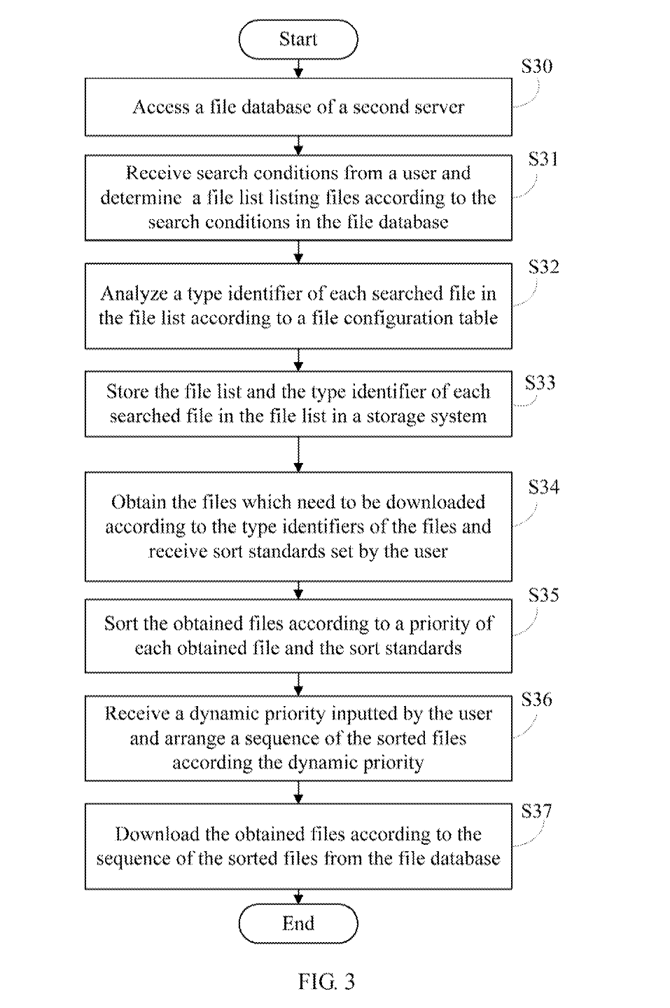

As shown in FIG. 2, the downloading system 10 includes a plurality of function modules, such as an accessing module 100, a searching module 101, an analyzing module 102, a storing module 103, a distinguishing module 104, a first sorting module 105, a second sorting module 106, and a downloading module 107. The modules 100-107 include computerized code in the form of one or more programs that are stored in the storage system 12. The computerized code includes instructions that are executed by the processor 11, to provide functions of the downloading system 10. Detailed functions of the modules 100-107 are given in reference to FIG. 3.

FIG. 3 is a flowchart of one embodiment of a method for downloading files. Depending on the embodiment, additional steps may be added, others removed, and the sequence of the steps may be changed.

In step S30, the accessing module 100 accesses the file database 20 of the second server 2.

In step S31, the searching module 101 receives search conditions from a user and determines a file list which lists files according to the search conditions in the file database 20. The file list includes the attributes of each searched file. In one embodiment, the search conditions may be a combination of a uploading date, a name of an agent, and an application number for example. For example, the searching module 101 searches the USPTO website for files that accord with the search conditions.

In step S32, the analyzing module 102 analyzes a type identifier of each searched file in the file list according to the file configuration table. Then the analyzing module 102 stores the type code of each searched file, and determines and marks whether each searched file needs to be downloaded according to the type code of each searched file. In one embodiment, the analyzing module 102 marks the searched file with a flag. If a searched file needs to be downloaded, the flag of the searched file may be “1”. If a searched file does not need to be downloaded, the flag of the searched file may be “0”.

In step S33, the storing module 103 stores the file list and the type code of each searched file in the file list in the storage system 12. The type code of each searched file can be stored in the attributes of each searched file.

In step S34, the distinguishing module 104 distinguishes between the files which need to be downloaded and the files which do not need to be downloaded according to the type identifiers of the files and obtains the files to be downloaded. The distinguishing module 104 receives sort standards set by the user. In one embodiment, the distinguishing module 104 provides a user interface for the user to input the sort standards. The sort standards may include deadline dates and types of the files, for example.

In step S35, the first sorting module 105 sorts the obtained files according to the priority of each obtained file and the sort standards. For example, the first sorting module 105 distinguishes between first files which have deadline dates and second files which do not have deadline dates from the obtained files. Then the first sorting module 105 sorts the first files according to the deadline dates. A first file having the earliest deadline date has a higher priority than another first file which has a later deadline date.

In step S36, the second sorting module 106 receives a dynamic priority inputted by the user and arranges a sequence of the sorted files according the dynamic priority. In one embodiment, the dynamic priority may be the uploading times of the sorted files.

In step S37, the downloading module 107 downloads the obtained files according to the sequence of the sorted files from the file database 20.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A first server, comprising:
a processor; and
a non-transitory computer-readable medium that stores one or more programs, which comprise instructions which when executed by the processor of the server, performs operations of:
(a) receiving search conditions and determining a file list listing files that matches the search conditions in a file database of a second server;
(b) analyzing a type identifier of each searched file in the file list according to a file configuration table stored in a storage system;
(c) storing the file list and the type identifier of each searched file on the file list in the storage system;
(d) obtaining files which need to be downloaded according to the type identifiers of the files and receiving sort standards set by a user;
(e) obtaining a downloading sequence of the obtained files by sorting the obtained files according to a priority of each obtained file and the sort standards; and
(f) downloading the obtained files according the downloading sequence.

2. The first server as claimed in claim 1, wherein the type identifiers include a first type identifier and a second type identifier.

3. The first server as claimed in claim 2, wherein the files having the first type identifier need be downloaded and the files having the second type identifier do not need be downloaded.

4. The first server as claimed in claim 1, wherein after operation (e) further comprising:
receiving a dynamic priority input by the user and arranging the downloading sequence according the dynamic priority.

5. A method being executed by a processor of a first server, comprising steps:
(a) receiving search conditions and determining a file list listing files that matches the search conditions in a file database of a second server;
(b) analyzing a type identifier of each searched file in the file list according to a file configuration table stored in a storage system;
(c) storing the file list and the type identifier of each searched file on the file list in the storage system;
(d) obtaining files which need to be downloaded according to the type identifiers of the files and receiving sort standards set by a user;
(e) obtaining a downloading sequence of the obtained files by sorting the obtained files according to a priority of each obtained file and the sort standards; and
(f) downloading the obtained files according the downloading sequence.

6. The method as claimed in claim 5, wherein the type identifiers include a first type identifier and a second type identifier.

7. The method as claimed in claim 6, wherein the files having the first type identifier need be downloaded and the files having the second type identifier do not need be downloaded.

8. The method as claimed in claim 5, wherein after step (e) further comprising: receiving a dynamic priority input by the user and arranging the downloading sequence according the dynamic priority.

9. A non-transitory computer-readable medium having stored thereon instructions that, when executed by a processor of a first server, cause the processor to perform operations of:
(a) receiving search conditions and determining a file list listing files that matches the search conditions in a file database of a second server;
(b) analyzing a type identifier of each searched file in the file list according to a file configuration table stored in a storage system;
(c) storing the file list and the type identifier of each searched file on the file list in the storage system;
(d) obtaining files which need to be downloaded according to the type identifiers of the files and receiving sort standards set by a user;
(e) obtaining a downloading sequence of the obtained files by sorting the obtained files according to a priority of each obtained file and the sort standards; and
(f) downloading the obtained files according the downloading sequence.

10. The non-transitory computer-readable medium as claimed in claim 9, wherein the type identifiers include a first type identifier and a second type identifier.

11. The non-transitory computer-readable medium as claimed in claim 10, wherein the files having the first type identifier need be downloaded and the files having the second type identifier do not need be downloaded.

12. The non-transitory computer-readable medium as claimed in claim 9, wherein after operation (e) further comprising: receiving a dynamic priority input by the user and arranging the downloading sequence according the dynamic priority.
